(19) United States
(12) Patent Application Publication
(10) Pub. No.: US 2008/0195977 A1
(43) Pub. Date: Aug. 14, 2008

(54) COLOR MANAGEMENT SYSTEM

(76) Inventors: Robert C. Carroll, Fishers, IN (US); Peter Polit, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 12/030,004

(22) Filed: Feb. 12, 2008

Related U.S. Application Data
(63) Continuation-in-part of application No. 11/575,349, filed on Oct. 16, 2007.
(60) Provisional application No. 60/900,818, filed on Feb. 12, 2007.

(51) Int. Cl. G06F 3/048

(52) U.S. Cl. 715/853

(57) ABSTRACT

A color management system is disclosed wherein a video is color graded for a plurality of different display devices or groups of display devices and the color grading information is used to adjust the video for presentment with a given display device.

### CROSS-REFERENCE TO RELATED APPLICATIONS

This application claims the benefit of U.S. Provisional Application Ser. No. 60/900,818, filed Feb. 12, 2007, titled COLOR MANAGEMENT SYSTEM, the disclosure of which is expressly incorporated by reference herein. This application is also a continuation-in-part of U.S. patent application Ser. No. 11/575,349, filed Oct. 16, 2007 as a 371 national stage application of PCT/US05/35942 which claimed the benefit of U.S. Provisional Application Ser. No. 60/615,613, filed Oct. 4, 2004, the disclosures of which are expressly incorporated by reference herein.

### FIELD OF THE INVENTION

The present invention relates to systems for the adjustment of color in video and in particular to the adjustment of color in a digital video to tailor the video for presentment with a plurality of different display devices.

### BACKGROUND OF THE INVENTION

Historically, display technology manufacturers, such as Cathode Ray Tube (CRT) manufacturers for the home market and film projectors for the theater market, have worked to standardize the technical performance of their displays and the content produced for playback on these displays was specifically altered to best match the display standard. This way the content was uniform and the display technology was uniform allowing content to look similar on each device.

Today, new display technology is being brought to market that exceeds the standard performance of past display technology. Exemplary display technologies such as LCD, Plasma, HD-ILA, and DLP have become more efficient to produce and are replacing CRT and film projection technology. Each of these display technologies has unique characteristics that are noticeable to human visual perception. These characteristics appear in human vision as differences in black to white luminosity (gamma), the ability of the display to reproduce colors (color gamut) and the precision of the color balance from black to white on the display (color temperature).

Even though the new display technology may exceed the past display technology, the content created for playback is restricted in performance in order to maintain uniformity in image quality across all displays. The emerging of a fully digital content delivery process allows dynamic manipulation of content to enhance the capabilities of display technology rather than limit them.

### SUMMARY OF THE INVENTION

In an exemplary embodiment of the present disclosure, a color management system is disclosed. In one embodiment, the color management system includes a library of color adjustment tools. In one embodiment, the library includes a multi-level hierarchical arrangement of color adjustment tools.

In an exemplary embodiment of the present disclosure, a method of presenting a tailored video with a desired display device is provided. The method including the steps of receiving a video; accessing a display information hierarchy for a plurality of display devices, for each display device the display information hierarchy including information related to one or more adjustments to the video for display of the video with the respective display device; and adjusting the video based on the information related to one or more adjustments to produce a tailored video with the desired display device. In one example, the method further includes the step of presenting the tailored video. In another example, the display information hierarchy includes a first level having multiple genres and for at least a first genre of the multiple genres of the first level having at least one sub-level providing multiple groupings within the first genre. In a variation thereof, the multiple genres are related to technologies and the multiple groupings are related to manufacturers. In a farther example, the display information hierarchy includes a first level having multiple genres and for at least a first genre of the multiple genres of the first level having at least two sub-levels each providing multiple groupings within the first genre. In a variation thereof, the multiple genres are related to technologies, the multiple groupings of the first sub level are related to manufacturers, and the multiple groupings of the second sub level are related to models of the a respective manufacturer. In yet another example, the display information hierarchy is provided with the video. In a variation thereof, the display information hierarchy is provided in metadata associated with the video. In another variation thereof, the display information hierarchy is provided in a watermark associated with the video. In a further variation thereof, the display information hierarchy is provided in ancillary data associated with the video. In yet another variation thereof, the step of accessing the display information hierarchy includes the steps of comparing an identifier for the desired display device to the one or more adjustments provided with the display information hierarchy; and selecting an adjustment from the one or more adjustments which has an identifier which is the closest to the identifier of the desired display device. In yet a further example, the display information hierarchy is provided independent from the video. In a variation thereof, the display information hierarchy is accessed over a network. In a further variation thereof, the video is received over the network. In yet a further variation thereof the video is stored on a portable device and the step of receiving the video includes the step of reading the video from the portable device. In still another example, the method further includes the steps of receiving an identification indication from the desired display identifying the desired display device; and based on the received identification information selecting from the display information hierarchy for a plurality of display devices, the information related to one or more adjustments to the video for the desired display device. In a variation thereof, the display information hierarchy includes a first level having multiple genres and the received identification indication from the desired display device includes information regarding which genre of the multiple genres the desired display device is in. In another variation thereof, the display information hierarchy further includes a first sub-level for the genre the desired display device is in, the first sub-level including multiple groupings and the step of adjusting the video based on the information related to one or more adjustments to produce a tailored video with the desired display device uses the information related to the genre of the desired display device unless the received identification information from the desired display device includes information regarding which grouping of the multiple groupings of the first sub-level the desired display device is in, in which case the step of adjusting the video based on the information related to one or more adjustments to produce a tailored video with the desired display device uses the information related to the grouping of the desired display device. In still a further example, at least one of the one or more adjustments specifies scene-by-scene adjustments. In yet still a further example, at least one of the one or more adjustments specifies frame-by-frame adjustments. In still a further example, at least one of the one or more adjustments specifies an adjustment to a sub-region of at least one frame.

In another exemplary embodiment of the present disclosure, a method of preparing a tailored video for presentment with a desired display device is provided. The method including the steps of: providing a video; and providing a display information hierarchy for a plurality of display devices, for each display device the display information hierarchy including information related to one or more adjustments to the video prior to presentment with the respective display device. In one example, the display information hierarchy is provided with the video. In a variation thereof, the display information hierarchy is provided in metadata associated with the video. In another variation thereof, the display information hierarchy is provided in a watermark associated with the video. In a further variation thereof, the display information hierarchy is provided in ancillary data associated with the video. In another example, the display information hierarchy is provided independent from the video. In a variation thereof, the display information hierarchy is accessible over a network. In a further example, at least one of the one or more adjustments specifies scene-by-scene adjustments. In yet another example, at least one of the one or more adjustments specifies frame-by-frame adjustments. In still another example, at least one of the one or more adjustments specifies an adjustment to a sub-region of at least one frame.

In a further exemplary embodiment of the present disclosure, a method of preparing a tailored video for presentment with a desired display device is provided. The method including the steps of providing a video; providing a library of information related to one or more adjustments to the video prior to presentment with the respective display device; and selecting from the library information related to one or more adjustments to the video for the desired display device if the desired display device is identified in the library, and in the case wherein the desired display device is not identified in the library then selecting information related to one or more adjustments to the video for a classification including the desired display device. In one example, the library is provided with the video. In a variation thereof, the library is provided in metadata associated with the video. In another variation, the library is provided in a watermark associated with the video. In a further variation, the library is provided in ancillary data associated with the video. In still another variation, the library is provided independent from the video. In another example, the library is accessible over a network. In still another example, at least one of the one or more adjustments specifies scene-by-scene adjustments. In yet another example, at least one of the one or more adjustments specifies frame-by-frame adjustments. In still a further example, at least one of the one or more adjustments specifies an adjustment to a sub-region of at least one frame.

In yet still another exemplary embodiment of the present disclosure, a method of improving the eventual display of a video on a display device having a plurality of display parameters is provided. The method including the steps of receiving a video from one or more cameras which are acquiring a scene; presenting at least a first image of the video on a video monitor; selecting a first display profile for a first display device from a plurality of display profiles; emulating at least the first image the video on the first display device based on the first display profile; presenting the emulated at least the first image of the video on the video monitor; adjusting the display of the at least the first image of the video to improve the eventual appearance of the at least the first image of the video on the first display device; storing the adjustment. In one example, the adjustment is provided with the at least the first image of the video. In a variation thereof, the adjustment is provided in metadata associated with the at least the first image of the video. In another variation thereof, the adjustment is provided in a watermark associated with the at least the first image of the video. In still another variation thereof, the adjustment is provided in ancillary data associated with the at least the first image of the video.

In still a further exemplary embodiment of the present disclosure, method of improving the display of a display device having a plurality of display parameters is provided. The method including the steps of receiving a video and an adjustment to the video which is provided to improve the presentation of the video with the display device, the adjustment being provided in a watermark; and displaying the video with the display device based on the adjustment provided in the watermark. In one example, the adjustment is selected from a plurality of adjustments. In another example, the adjustment is related to a group of display devices including the display device. In a further example, the adjustment specifies scene-by-scene adjustments. In yet another example, the adjustment specifies frame-by-frame adjustments. In still a further example, the adjustment specifies an adjustment to a sub-region of at least one frame.

In still yet a further exemplary embodiment of the present disclosure, method of improving the display of a display device having a plurality of display parameters is provided. The method including the steps of providing a video and an adjustment to the video which is provided to improve the presentation of the video with the display device, the adjustment being provided in a watermark; and displaying the video with the display device based on the adjustment provided in the watermark. In one example, the adjustment is selected from a plurality of adjustments. In another example, the adjustment is related to a group of display devices including the display device. In a further example, the adjustment specifies scene-by-scene adjustments. In yet another example, the adjustment specifies frame-by-frame adjustments. In still a further example, the adjustment specifies an adjustment to a sub-region of at least one frame.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a representation of a color management system;

FIG. 2A is a representation of a display profile library;

FIG. 2B is a representation of a display profile adjustment library;

FIG. 3 is a representation of a portion of the color management process of FIG. 1;

FIG. 4 is a representation of portions of a video having display adjustment information for presentment of the portions of the video with a first display device;

FIG. 5 is a representation of portions of a video having display adjustment information for presentment of the portions of the video with three display devices;

FIG. 6 is a representation of a visualization device for use in production and post-production of the video;

FIG. 7 is a representation of a portion of the visualization device of FIG. 6;

FIG. 8 is a representation of decoder at a given display device which adjusts the video for presentment with the given display device; and

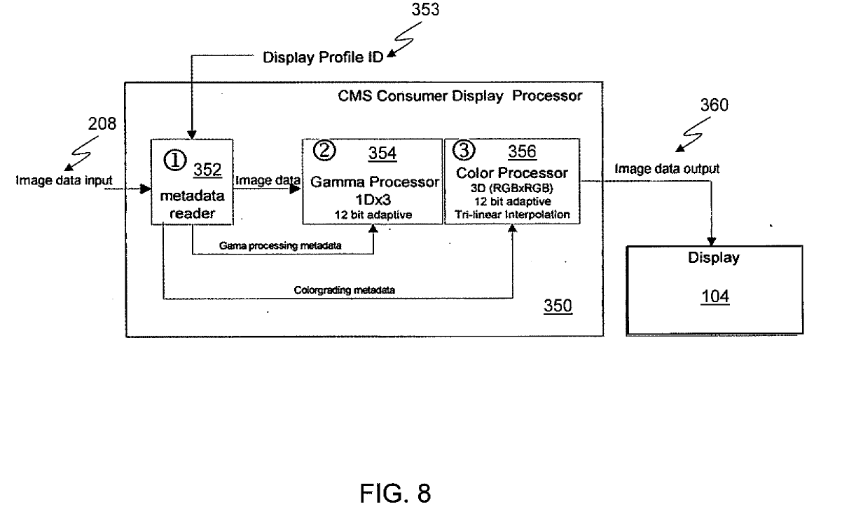

FIG. 9 is a representation of receiving the image data separate from the adjustment data.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

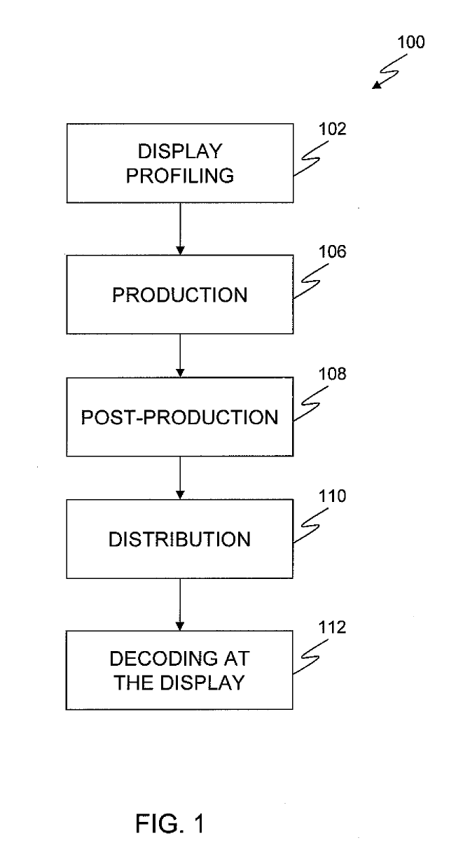

Referring to FIG. 1, a color management system 100 is represented. Color management system 100 may be implemented by software and/or firmware being executed by one or more processors. Color management system 100 provides improved quality of a reproduction of video independent of the display technology all from a single stream of data. Exemplary types of video include live recordings, animation, special effects. It should be understood that the techniques disclosed herein may be used at any point from acquisition of the images of a video to final production of a video. As used herein, the term video is a generic expression for a collection of motion images.

Color management system 100 includes generating a plurality of display profiles 102 for a plurality of display devices 104. Display profiles 102 as explained herein provide information to emulate a given display device with another display device. Display profiles 102 may be provided by a manufacturer of the given display device 104. Exemplary display devices 104 include consumer displays such as televisions, computer monitors, personal playback devices, such as iPods from Apple, cell phones, film projectors, and other devices which are suitable for displaying a video work. As used herein, the term display device also includes components connected to a traditional display device for the purpose of providing videos to the traditional display device. Such components include, DVD players, cable set-top boxes, satellite receivers, iPods when connected to a display device, and other components which provide videos to a traditional display device.

As explained herein, display profiles 102 may be used to in the pre-production process 106 and also in the post-production process 108. During the pre-production process 106 and the post-production process 108, one or adjustments may be stored for use with the video for a given display devices 104. The one or more adjustments being determined through the use of the display profiles 102 for the respective display devices 104. In addition, the one or more adjustments may be static for the entire video, changing on a scene-by-scene basis, and/or changing on a frame-by-frame basis. In one embodiment, the video monitor disclosed in U.S. patent application Ser. No. 11/575,349, the disclosure of which is expressly incorporated by reference herein, is used during the pre-production process 106 and post-production process 108 to emulate a given display based on the display profiles 102. The video monitor may then provide adjustment information for the given display which may be provided in various locations as discussed herein.

The adjustments for each display device for a given video are associated with the given video for distribution, as represented by block 110. The adjustments for a given display device are decoded and the video is adjusted based thereon, as represented by block 112.

In one embodiment, the adjustments are provided with the video. In one example, the adjustments are provided in metadata associated with the video. In one example, the adjustments are provided in a watermark associated with the video. In one example, the adjustments are provided in ancillary data associated with the video. In one embodiment, the adjustments are provided independent of the video. In one example, a display device may obtain the adjustments over a network. The display device may provide an identification of the video and of itself and receive back the adjustment for that video played on that category of display device.

In one embodiment, it is the receiver component (cable receiver or satellite receiver, for example) which provides the identity information regarding the display device and/or the video to be presented over the network. In one example, the cable or satellite provider then supplies the adjustments. In one example, the content provider, such as the studio or production company provides the adjustments.

Color management system 100 allows a cinematographer to develop looks for a given display of each scene or frame of a video at the point of acquisition. The looks may be applied to multiple display profiles thus creating differing looks for a plurality of display devices on a scene-by-scene basis and/or a frame-by-frame basis. These looks may be inserted as metadata, watermarks, and other types of data into the digital video data stream or associated therewith. During post production final looks on each scene and/or each frame may set and tested to ensure the proper look is achieved on all known displays. These final looks may be inserted as metadata, watermarks, and other types of data into the digital video data stream or associated therewith. As explained herein, the video may be distributed with adjustments information which recreates the desired looks on a given display device. Each display device may include a processor which processes the adjustment data and adjusts the video based thereon to provide the intended scene look with the display device. In this way, color management system 100 delivers color specific information which adapts the image to a particular display's technology and colorimetry profile on a scene-by-scene basis or frame-by-frame basis.

### Display Profiling

As represented by block 102, profiles of different display technologies are obtained. In one embodiment, the display technologies are identified by genre (exemplary genres include LCD, CRT, plasma, projector), manufacturer, and model number. This information may be stored in a profile library. The profile library will be used in the production process 106 and the post production process 108 to develop a library of adjustments which are tied to the respective display devices and used in the decoding step 112.

Display profiling is a known technology. In one embodiment, a variety of differing display technologies forming a diversity of display types and capabilities are acquired as a core sample. Preferably, at least one display device from each genre is represented. Next, each display in the core sample is tested to determine its display characteristics. In one embodiment, the profiling methods include the measurement of four basic characteristics in a display technology. These characteristics include, gamma (black to white luminosity), color temperature (the precision of the color balance from black to white on the display), color gamut (the ability of the display to reproduce colors) and, contrast ratio (the ratio of the lowest level of light output for the color black and the highest level of light output for the color white). As mentioned in U.S. Provisional Application 60/900,818, several references are provided which provide the mathematical expressions of gamma, color gamut and manipulation of color temperature.

Gamma of a display device may be determined through the use of a spectral radiometer such as a PR650 available from Photo Research, Inc located in 9731 Topanga Canyon Place, Chatsworth, Calif. 91311-4135. The PR 650 is used to measure the light output of the display as it is stepped through seventeen levels starting with black and going to white. This is independent of the displays native bit depth or spatial resolution.

Color Temperature of a display shows how the display deviates in the output light spectrum as it goes from black to white. A viewer may see a slight purple or blue shade when looking at a low level (black) output from the display and then see a pinkish or red shade when viewing high level output (white) from the display. Color temperature is profiled by reading the color spectrum output in International Commission on Illumination (“CIE”) x,y color coordinates. For purposes of charting and showing what the profile may look like graphically from black levels to white levels the CIE x,y, color coordinates is translated to color temperature in degrees Kelvin.

Color Gamut may be determined with a standard diagram provided by CIE for measuring the extent or gamut of human visual perception. This same diagram can be used to show the limits of color reproduction for display technology. Profiling color gamut of a display requires a spectral radiometer to measure the CIE coordinate values (x,y) for the Red, Green and Blue extremes of the display under profile.

Contrast Ratio is the ratio of the luminance output from full white to the luminance output of black. The higher the contrast ratio the more bit depth the image data needs to take advantage of the contrast ratio. An image that goes from black to full white from the left side of the screen to the right side of the screen will show scalloping or stair steps if the number of levels produced exceeds the combination of the contrast ratio and the screen spatial resolution.

In one embodiment, the characteristics of a given display are profiled until enough information is known to provide a 1D×3 lookup table (LUT) that translates 10 bit R,G,B, image data adjusting any needed gamma curves along the data stream and a 3D look up table (LUT) that translates 10 bit R,G,B image data translating any color values in the data stream. In one embodiment, the 1D×3 LUT is generated from a 17 point table which may be loaded into memory of a display device. Data values between the points are interpolated by software of the display device. In one embodiment, the 3D LUT is generated from a 64×64×64 point table loaded into memory of the display device. Data values between the points are calculated through tri-linear interpolation by software of the display device. With these tools a display device, such as the video monitor disclosed in U.S. patent application Ser. No. 11/575,349, the disclosure of which is expressly incorporated by reference herein, may be used to emulate a given display.

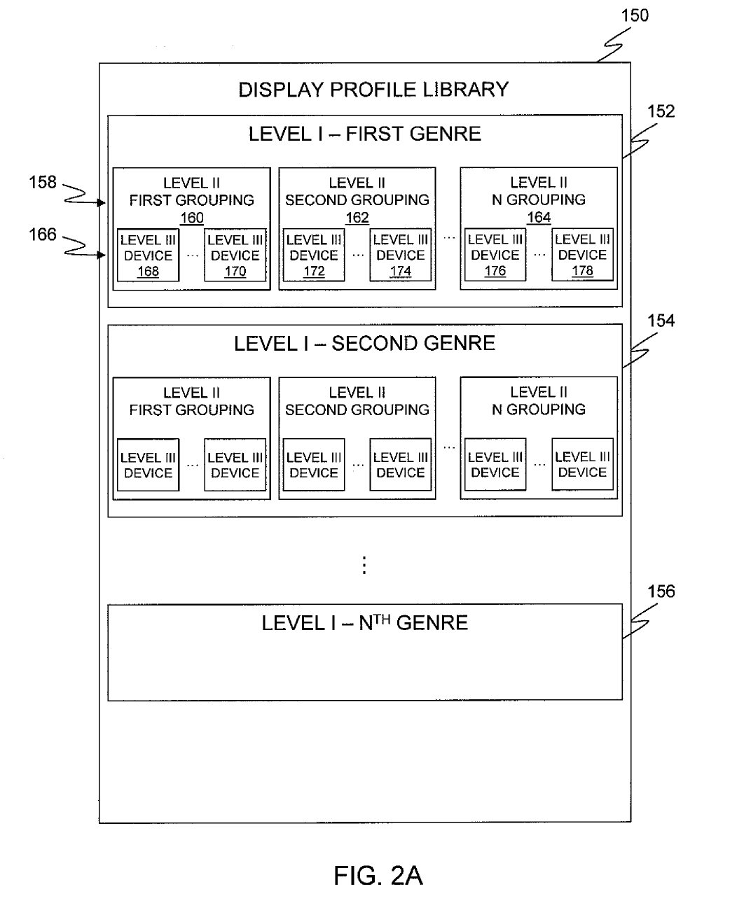

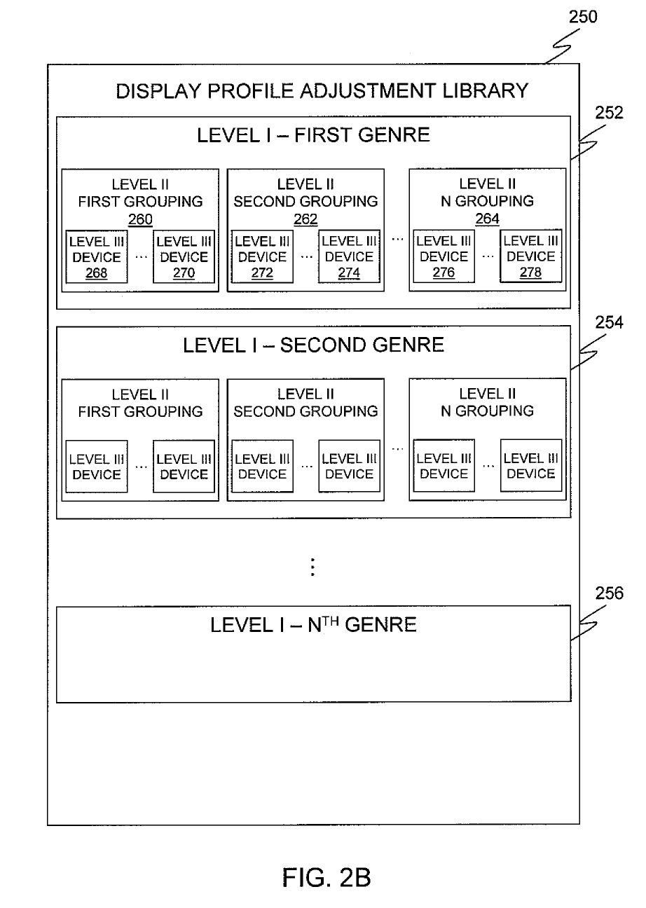

Referring to FIG. 2A, an exemplary representation of the display profile library 150 is shown. Display profile library 150 may be stored in a memory which is accessible by the display device for which it will be used, such as the video monitor disclosed in U.S. patent application Ser. No. 11/575,349, the disclosure of which is expressly incorporated by reference herein. Display profile library 150 includes a plurality of genres, genre 152, genre 154, and genre 156 being illustrated. In one embodiment, each genre relates to a given type of display technology, such as LCD, plasma, projectors, and other types of display technologies. Each genre may be profiled to provide an approximate representation of the members of that genre. For example, assuming that genre 152 corresponds to LCD displays, a sampling of LCD displays may be profiled and then an average profile is determined which represents an average profile for that genre. In one example, as new display devices are added to a genre, the overall profile for the genre may be adjusted.

By having an overall profile for a genre available for use by a production team, the production team does not need to profile each device within a given genre, but rather may be satisfied that the video has been tailored to an average display within a given genre. This may be useful in an image acquisition stage wherein the production team wants to generally tailor the images being captured for a genre, but does not want to take the time to check all devices within a genre. Further, as mentioned herein, a video once distributed may be desired to be presented with a display device for which a specific adjustment has not been created, in this situation the decoder processor may use the less specific adjustment for the overall genre which was determined through the use of the overall genre profile by the production team.

Each genre in the display profile library 150 may include multiple sub levels which provide more specific profiles for devices within a given genre. Referring to genre 152, a first sub-level 158 is represented by grouping 160, grouping 162, and grouping 164. Further, a second sub-level 166 is represented by devices 168-178. Devices 168 and 170 are contained in grouping 160. Devices 172 and 174 are contained in grouping 162. Devices 176 and 178 are contained in grouping 164. Each of groupings 160-164 and devices 168-178 have their own respective profiles which may be used to tailor the appearance of the video to the respective grouping and/or device. Further, in one embodiment, a given display device may have sub-levels wherein the display device has pre-programmed modes of display, such as “SPORTS”, “MOVIES” and so on.

An exemplary display profile library 150 is provided in the following table.

| | |
|---|---|
| FIRST GENRE | CRT |
| FIRST SUB-LEVEL | P22 PHOSPHOR |
| SECOND SUB-LEVEL | COMPUTER MONITOR |
| THIRD SUB-LEVEL | DELL 2465 |
| THIRD SUB-LEVEL | ILYAMA 1700 SERIES |
| FIRST SUB-LEVEL | B22 PHOSPHOR |
| SECOND SUB-LEVEL | TELEVISION |
| THIRD SUB-LEVEL | CURTIS MARTIN 200 SERIES |
| FIRST SUB-LEVEL | EBU/SMPTE B PHOSPHOR |
| SECOND SUB-LEVEL | VIDEO MONITOR |
| THIRD SUBLEVEL | SONY |
| FOURTH SUB-LEVEL | BVM SERIES |
| FOURTH SUB LEVEL | PVM SERIES |
| SECOND SUB-LEVEL | TELEVISION |
| THIRD SUB-LEVEL | SONY |
| THIRD SUB-LEVEL | RCA |
| SECOND GENRE | LCD |
| FIRST SUB-LEVEL | TFT ACTIVE MATRIX |
| SECOND SUB-LEVEL | IN PLANER |
| THIRD SUB-LEVEL | SAMSUNG |
| THIRD SUB-LEVEL | LG |
| SECOND SUB-LEVEL | TWISTED NEMATIC |
| FIRST SUB-LEVEL | TFT PASSIVE |

In the above exemplary display profile library 150, the genres correspond to types of display technology, the first sub-levels correspond to categories of display technology within a given genre, the second sub-levels correspond to further refinements in the categories of the display technologies, and the third sub-levels correspond to specific manufactures or display devices. The genres and levels may be used to represent any number of classifications of the display technology. Further, the number of the genres and sub-levels may be adjusted based on the classification scheme chosen.

### Production Pre-Visualization

The display profile library 150 may be used to simulate a specific display or a category or sub-category of a plurality of display devices on a reference display for purposes of determining the best colorgrade for the content.

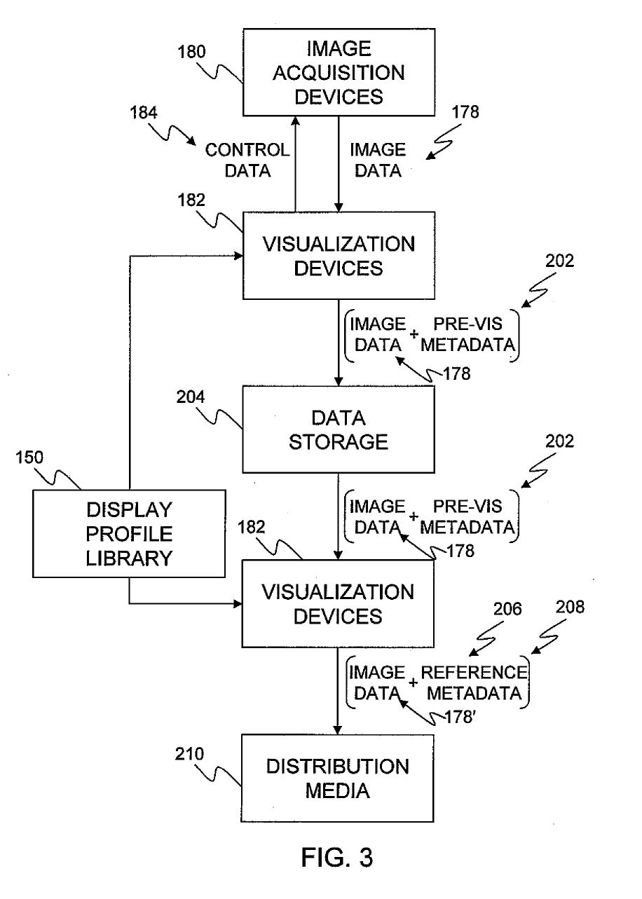

A cinematographer wants to acquire an image that communicates the mood of the scene being shot. It is important to understand that the image 178 (see FIG. 3) captured by the camera 180 will undergo many enhancements and manipulation in the post production process. A visualization device 182, such as the video monitor disclosed in U.S. patent application Ser. No. 11/575,349, the disclosure of which is expressly incorporated by reference herein, is used to observe the images being captured by the camera. The user of the video monitor would select a display profile from display profile library 150 through a user interface presented with the video monitor. The visualization device 182 may also send control data 184 to camera 180 to control its operation.

The visualization device 182 may be used to pre-visualize color looks for each scene being shot or each frame being captured. The visualization device 182 may be used to pre-visualize the scene or frame as it would be displayed on a given genre, category of display device, sub-category of display device, and/or specific display device. As stated herein, display profile library 150 includes the information needed to emulate various display technologies.

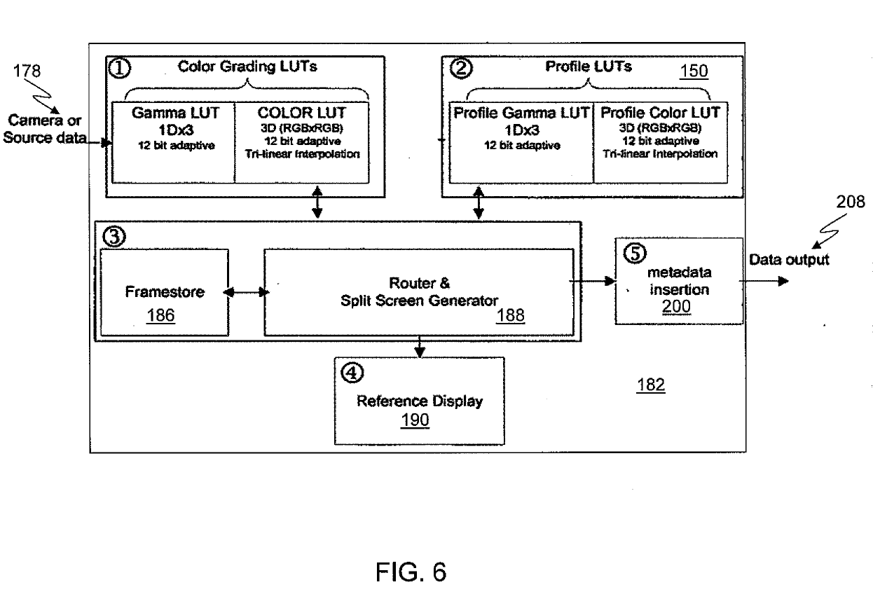

Referring to FIG. 6, the operation of visualization device 182 is illustrated. The camera (or other source) data 178 is provided to visualization device 182. Visualization device 182 includes a framestore 186 to store the source data 178 and a split screen generator 188 which presents multiple renderings of the images in the framestore 186. In one embodiment, split screen generator 188 presents an unaltered version of the images stored in framestore 186 and an altered version of the images. The altered version of the images may represent how the images would appear on a reference display 190. Reference display 190 is a simulation of a real display device or a collection of display devices, such as a genre. Reference display 190 is simulated based on the information for the desired display device or collection of display devices in display profile library 150.

The operator of visualization device 182 may then adjust the simulated image on the reference display 190. In one embodiment, adjustments to the simulated image are made by altering a 1D×3 lookup table (LUT) 192 that translates 10 bit R,G,B, image data adjusting any needed gamma curves along the data stream and a 3D look up table (LUT) 194 that translates 10 bit R,G,B image data translating any color values in the data stream. In one embodiment, the 1D×3 LUT is generated from a 17 point table loaded into memory. Data values between the points are interpolated. In one embodiment, the 3D LUT is generated from a 64×64×64 point table loaded into memory. Data values between the points are calculated through tri-linear interpolation.

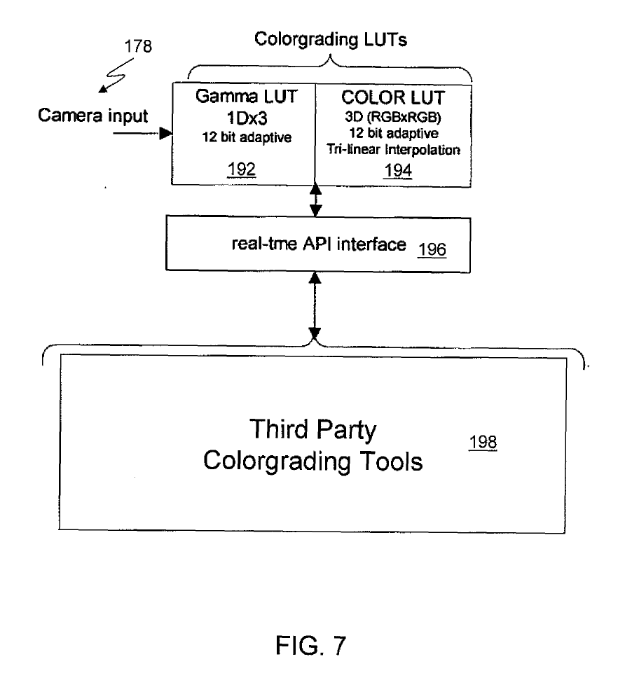

Referring to FIG. 7, in one embodiment, visualization device 182 includes an API interface 196 to third party colorgrading tools 198 which are used to determine LUT 192 and LUT 194. Exemplary third party colorgrading tools include Pablo colorgrading product available from Quantel located at 1950 Old Callows Road, Vienna, Va. 22182; SpeedGrade colorgrading product available from Iridas located at PO Box 633, Tujunga Calif. 91043; and RESOLVE and 2K PLUS colorgrading products available from da Vinci located at 4397 NW 124 Avenue, Coral Springs, Fla. 33065.

Returning to FIG. 6, a metadata insertion component 200 takes the gamma information 192 and colorgrade information 194 related to the simulated display profile and inserts the information as metadata in the data stream. Metadata packets are currently defined in the SMPTE 249 and DCI 1.0 specifications. In one embodiment, the gamma information 192 and colorgrade information 194 are provided in watermarks associated with the images.

Although a metadata insertion component is illustrated, it should be understood that it is contemplated to include gamma information 192 and colorgrade information 194 in data locations other than metadata, such as watermarks. In these cases, component 200 inserts the gamma information 192 and colorgrade information 194 in those other data locations. In one embodiment, a watermark is data embedded directly with the video content which is imperceptible by viewing the video, but which is readable by computer systems. In one example, the gamma information 192 and colorgrade information 194 is provided as a watermark which is represented by slight alterations of values of a plurality of pixels in one or more images of the video. The gamma information 192 and colorgrading information 194 may be provided as an overall adjustment for the entire video or may vary throughout the video, such as on a frame-by-frame basis and/or a scene-by-scene basis.

In one embodiment, the gamma information 192 and colorgrade information 194 are provided in the ancillary data locations of the images or are otherwise associated with the images. Additional exemplary locations for gamma information 192 and colorgrade information 194 include outside area of interest data-marking such as encoding provided in the audio channel, encoding provided in the closed captioning,or encoding provided in the vertical interval time code (VITC). The resultant image data and display information 202 (see FIG. 3) are stored in a data storage device 204 (see FIG. 3) for further manipulation in post-production.

In one embodiment, differing gamma information 192 and colorgrade information 194 may be specified for different portions of a given image. As such, the overall image may have associated therewith a first gamma information 192 and colorgrade information 194 while a portion of the image has a second gamma information 192 and/or colorgrade information 194.

With visualization device 182, the cinematographer may compare and adjust the colorgrade while looking at both profiled data and non-profiled data. Once an appropriate colorgrade is determined (whether it is a pre-visualization or final grade) the grade data associated with the profile ID is inserted into the digital content data stream as metadata or otherwise associated with the digital content data stream. This process provides a basic translation of the source data values to another set of values creating a desired result while viewing the data through a display profile such that:

Image Data_{RAW}+Colorgrade_{LUT}+Display Profile_{LUT}=Desired Result

### Where:

Image Data_{RAW}=The non-graded or limited grade image data Colorgrade_{LUT}=The lookup table information generated by the Content producers that is embedded in Image Data_{RAW} along with the profile ID of the reference display associated with each grade.
   Display Profile_{LUT}=Is the profile of the display in use or under emulation.

The purpose of this technology is to provide a preview of the final look on a given display or display group while acquiring the raw image data. The point of image acquisition provides the widest degree of influence on how the final image will look. At this point the cinematographer may generate and preview a look for each scene on a plurality of display technologies. When the cinematographer is satisfied with the look for that scene the adjustments made to the images, illustratively the Colorgrade_{LUT}, may be associated with the images. The adjustments are stored such that the Image Data_{RAW} may still be observed, if desired in later processing. Exemplary post-processing activities include special effects and final color grading.

Referring to FIG. 2B, an exemplary representation of the storage of the adjustments to the video is shown. FIG. 2B illustrates a display profile adjustment library 250 which includes display adjustment information arranged in a hierarchy manner similar to the display profile library 150. If a cinematographer performs an adjustment on the video for first genre 152 of display profile library 250 those adjustments may be stored as adjustments 252. Adjustments include an identification to identify what display device or group of display devices they relate to. As such, adjustment 252 would include an identifier for first genre 152.

In one embodiment, the identifier associated with each adjustment is a run-length encoding. In one example, the identifier is of the form:

ID=[Level I][Level II][Level III]

By way of example, two adjustments are stored for a given video. A first adjustment has a first ID (ID=[LCD]). A second adjustment has a second ID (ID=[LCD][Samsung]). Now assume a post-production user want to emulate a Samsung LTA 260 LCD television. The user would select the display profile from library 150 corresponding to a Samsung LTA 260 LCD television. Visualization device 182 would then review the adjustments stored for the given video. Visualization device 182 would determine that an adjustment is provided for Level I, LCD televisions. Visualization device 182 would then look to see if a more specific adjustment is provided. Visualization device 182 would determine that an adjustment is provided for Level II, Samsung LCD televisions. Visualization device 192 would then again check for a more specific adjustment, such as for model number LTA 260. Finding none provided, visualization device 182 would use the adjustment with the ID=[LCD][Samsung].

Just like display profile library 150, display profile adjustment library 250 includes a plurality of levels which represent the adjustments for various groupings of display devices and/or specific display devices. In one embodiment, for a given video, the cinematographer may only provide adjustments 252, 254, and 256 which correspond to the top level genres 152, 154, and 156. In one embodiment, for a given video, the cinematographer may only provide adjustments 252-256, 260-264, and 268-278 which correspond to the top level genres 152-156 and all of the illustrated groupings in levels 158 and 166 of first genre 152.

### Post Production—CMS Reference

Returning to FIG. 3, once the resultant image data and display information 202 has been stored in data storage device 204, the post-production process begins. One of the final steps in the post production process is color grading. At this point in the process a “Colorist” makes final color adjustments or grades to the video on a scene-by-scene basis or frame-by-frame basis. The colorist may use visualization device 182 to view the image data 178 and use the display adjustments associated with the image data to see the look intended by the cinematographer during production for a specific display device or a grouping of display devices. Visualization device 182 uses display profile library 150 to emulate a given display and the display adjustments then show the adjustments to the video on that display device or group of display devices.

In the past the colorist only had to generate two color grades, one for film distribution and one for video distribution. The changes in consumer displays and alternative programming channels such as the internet have created a plethora of display types and distribution schemes all which alter the intended color look and quality. Color has a huge impact on how a story is told. The feel of a cold gloomy winter day is difficult to capture from a camera when the scene is shot from a sound stage. It is the colorist job to alter the captured image to convey the time, temperature, environment and mood of each scene. When the display technology is significantly different from the technology used by the colorist this mood can be lost or a special effect may not look as real. By using visualization device 182, the colorist may adjust the look for each type of display on a scene-by-scene basis or frame-by-frame basis while producing only one master. The final adjustments 206, just like above in the production process are stored associated with the image data 178′. Image data 178′ may be identical to image data 178 or may have been updated to include overall changes to image data 178 for all display devices. The final adjustments 206 include identifiers to identify the display device or group of display devices the respective adjustment is associated therewith.

### Distribution

The master data file 208 which includes the image data 178′ and the final adjustments 206 is then stored on distribution media 210 for distribution and ultimate presentment on a plurality of display devices. Exemplary distribution media include satellite broadcast, cable broadcast, internet streaming, on-demand content download, dvds, memory card, and any device including pre-recorded digital content. This data is maintained through the replication and distribution process for final delivery to the viewer.

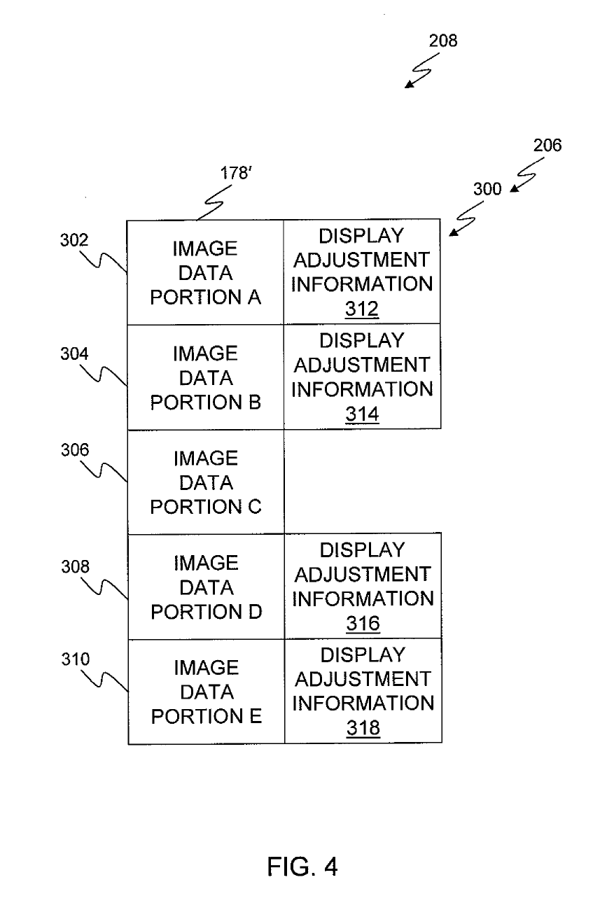

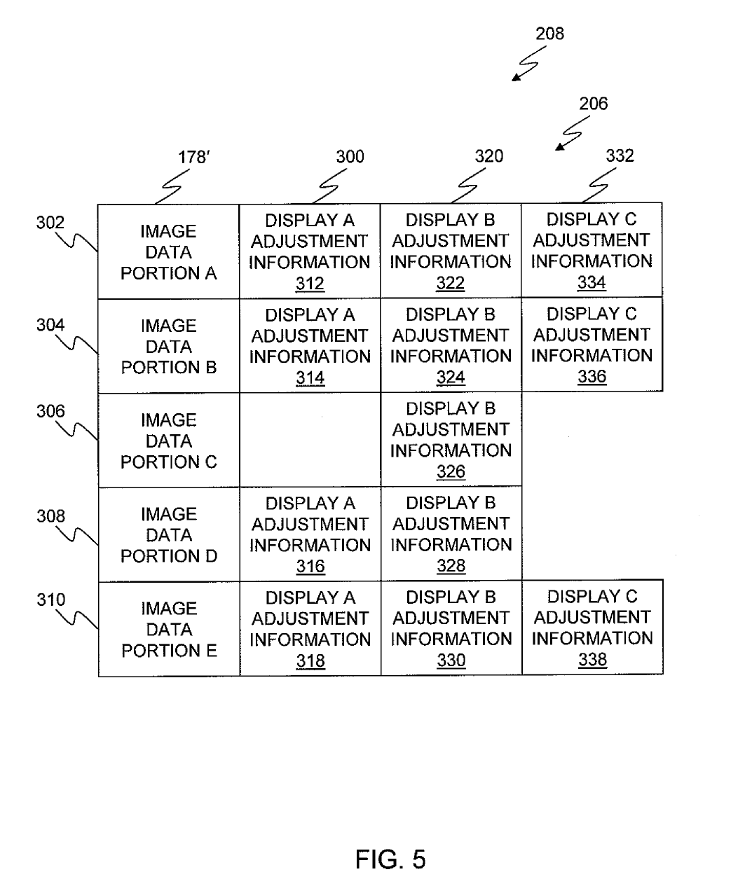

Referring to FIGS. 4 and 5, representations of the master data file 208 are shown. Referring to FIG. 4, image data 178′ and adjustments 206 for a first display device 300 are illustrated. Based on the discussions wherein, display device 300 may be instead a group of display devices. Image data 178′ includes image data portion A 302, image data portion B 304, image data portion C 306, image data portion D 308, and image data portion E 310.

For image data portion A 302, adjustment 312 is provided for presentment of image data portion A 302 on a display device 300. For image data portion B 304, adjustment 314 is provided for presentment of image data portion B 304 on a display device 300. For image data portion C 306, no adjustment data is provided. In one embodiment, the lack of adjustment data means image data portion C 306 should be presented without adjustment. In one embodiment, the lack of adjustment data means image data portion C 306 should be presented with the last identified adjustment, adjustment 314 which was introduced with image data portion B 304. For image data portion D 308, adjustment 316 is provided for presentment of image data portion D 308 on a display device 300. For image data portion E 310, adjustment 318 is provided for presentment of image data portion E 310 on a display device 300. The image data portions 302-310 correspond to segments of the image data 178′. An exemplary segment is a scene. Although the discussions have involved the overall adjustment of the image data 178′, it is possible to provide a first adjustment to the overall image data 178′ of a scene and to provide a second adjustment to a portion of the image data 178′ of a scene.

Referring to FIG. 5, the adjustments for presentments with two additional display devices 320 and 332 are shown. For display device 320, adjustments 322-330 are provided for image data portions 302-310, respectively. For display device 332, adjustments 334, 336, and 338 are provided for image data portions 302, 304, and 310, respectively.

### Decoding at the Display

At the display device 104 the master data file 208 is received. A processor associated with display device 104 includes a metadata reader 352 is provided. Metadata reader 352 monitors the metadata 206 on the incoming data stream 208 and detects metadata matching the profile ID 353 of the consumer display. In one embodiment, the profile ID 353 is provided through extended display identification data (ED ID) provided by the display device 104. Exemplary EDID data includes manufacturer name, product type, phosphor or filter type, timings supported by the display, display size, luminance data, and pixel mapping data for digital displays. In one embodiment, processor 350 provides a prompt to the user to inquiry about display device 104 so that the profile ID may be inferred from the responses received.

The metadata reader 352 scans the incoming data stream 208 for any metadata which may be relevant to display device 104. For example, the colorist may have only specified adjustments for the genre that display device 104 belongs. Metadata reader 352 uses this adjustment data unless more specific adjustment data for display device 104 is also provided. An example case wherein more specific adjustment data is provided is where the colorist provides adjustment data for a group of display devices in that genre which includes display device 104, such as adjustments for a particular manufacturer. In another case, the colorist provided adjustments for the particular display device 104.

By way of example, two adjustments are stored for a given video for distribution. A first adjustment has a first ID (ID=[LCD]). A second adjustment has a second ID (ID=[LCD][Samsung]). Now assume metadata reader 352 is associated with a Samsung LTA 260 LCD television. Metadata reader 352 reviews the adjustments stored for the given video. Metadata reader 352 then determine that an adjustment is provided for the Level I group of display devices it has associated with itself, LCD televisions. Metadata reader 352 then look to see if a more specific adjustment is provided. Metadata reader 352 determines that an adjustment is provided for the Level II group of display devices it has associated with itself, Samsung LCD televisions. Metadata reader 352 then again check for a more specific adjustment, such as for model number LTA 260. Finding none provided, metadata reader 352 would use the adjustment with the ID=[LCD][Samsung].

Metadata reader 352 provides the most relevant adjustments to a gamma processor 354 and a color processor 356 which each adjust image data 178′ to produce image data 360 for presentment with display device 104. The gamma processor 354 adjusts gamma on the incoming data stream 208 according to the information provided by the metadata reader 352. The color processor 356 adjusts color on the incoming data stream 208 according to the information provided by the metadata reader 352.

Although a metadata reader component 352 is illustrated, it should be understood that it is contemplated to include gamma information 192 and colorgrade information 194 in data locations other than metadata, such as watermarks. In these cases, component 352 looks for the gamma information 192 and colorgrade information 194 in those other data locations.

In one embodiment, the final adjustments 206 are based on the factory settings of the display device. In one embodiment, processor 350 upon identifying a final adjustment for a given video sends control information to the display device to reset to the factory settings so that the video is displayed as intended. Processor 350 may then adjust the display settings following the video to the settings before the video. In one embodiment, processor 350 detects the current settings of the display device and generates an additional adjustment to be applied to the video, the additional adjustment taking into account the offsets from the factory settings.

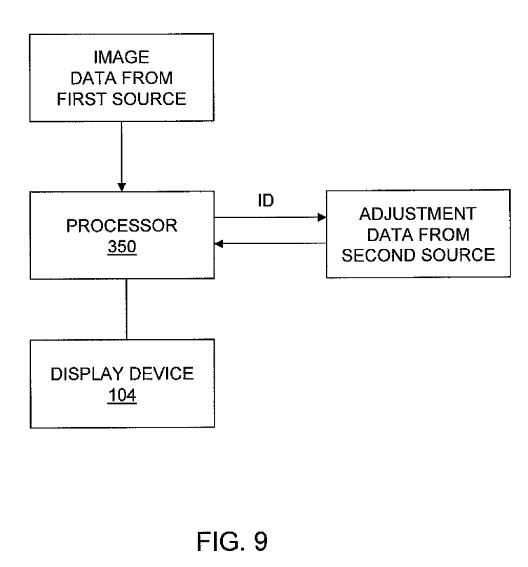

Referring to FIG. 9, in one embodiment, processor 350 receives the image data of the video separate from the adjustment data. As illustrated, the image data and the adjustment data are provided by separate sources, although they may be provided by the same source just as separate streams of data. In one embodiment, processor 350 receives the image data and then sends the ID associated with the display device 104 to request the appropriate adjustment 208. In one example, the ID is sent over and the adjustment is received over the Internet. Processor 350 then uses the received adjustment 208 to present the image data with display device 104. This arrangement allows a content provider to continue to update the plurality of adjustments 208 over time for image content that has already been purchased. For example, a consumer may purchase a dvd and then years later want to play that dvd on the new display technology they have purchased. The content provider using this arrangement may provide an adjustment for that new display technology for the video, even though that adjustment was not available at the time the dvd was sold.

The use of adjustments 208 for various display technologies also allows a consumer to enjoy tailored videos on multiple displays. The consumer may download a digital copy of the video and view it on their iPod device with a first adjustment and then view the video on their home theater system with a second adjustment.

Although the invention has been described in detail with reference to certain preferred embodiments, variations and modifications exist within the spirit and scope of the invention as described and defined in the following claims.

1. A method of presenting a tailored video with a desired display device; the method including the steps of:
receiving a video;
accessing a display information hierarchy for a plurality of display devices, for each display device the display information hierarchy including information related to one or more adjustments to the video for display of the video with the respective display device; and
adjusting the video based on the information related to one or more adjustments to produce a tailored video with the desired display device.

2. The method of claim 1, further including the step of presenting the tailored video.

3. The method of claim 1, wherein the display information hierarchy includes a first level having multiple genres and for at least a first genre of the multiple genres of the first level having at least one sub-level providing multiple groupings within the first genre.

4. The method of claim 3, wherein the multiple genres are related to technologies and the multiple groupings are related to manufacturers.

5. The method of claim 1, wherein the display information hierarchy includes a first level having multiple genres and for at least a first genre of the multiple genres of the first level having at least two sub-levels each providing multiple groupings within the first genre.

6. The method of claim 5, wherein the multiple genres are related to technologies, the multiple groupings of the first sub level are related to manufacturers, and the multiple groupings of the second sub level are related to models of the a respective manufacturer.

7. The method of claim 1, wherein the display information hierarchy is provided with the video.

8. The method of claim 7, wherein the display information hierarchy is provided in metadata associated with the video.

9. The method of claim 7, wherein the display information hierarchy is provided in a watermark associated with the video.

10. The method of claim 7, wherein the display information hierarchy is provided in ancillary data associated with the video.

11. The method of claim 7, wherein the step of accessing the display information hierarchy includes the steps of:
comparing an identifier for the desired display device to the one or more adjustments provided with the display information hierarchy; and
selecting an adjustment from the one or more adjustments which has an identifier which is the closest to the identifier of the desired display device.

12. The method of claim 1, wherein the display information hierarchy is provided independent from the video.

13. The method of claim 12, wherein the display information hierarchy is accessed over a network.

14. The method of claim 13, wherein the video is received over the network.

15. The method of claim 13, wherein the video is stored on a portable device and the step of receiving the video includes the step of reading the video from the portable device.

16. The method of claim 1, further including the steps of
receiving an identification indication from the desired display device identifying the desired display device; and
based on the received identification information selecting from the display information hierarchy for a plurality of display devices, the information related to one or more adjustments to the video for the desired display device.

17. The method of claim 16, wherein the display information hierarchy includes a first level having multiple genres and the received identification indication from the desired display device includes information regarding which genre of the multiple genres the desired display device is in.

18. The method of claim 17, wherein the display information hierarchy further includes a first sub-level for the genre the desired display device is in, the first sub-level including multiple groupings and the step of adjusting the video based on the information related to one or more adjustments to produce a tailored video with the desired display device uses the information related to the genre of the desired display device unless the received identification information from the desired display device includes information regarding which grouping of the multiple groupings of the first sub-level the desired display device is in, in which case the step of adjusting the video based on the information related to one or more adjustments to produce a tailored video with the desired display device uses the information related to the grouping of the desired display device.

19. The method of claim 1, wherein at least one of the one or more adjustments specifies scene-by-scene adjustments.

20. The method of claim 1, wherein at least one of the one or more adjustments specifies frame-by-frame adjustments.

21. The method of claim 1, wherein at least one of the one or more adjustments specifies an adjustment to a sub-region of at least one frame.

22. A method of preparing a tailored video for presentment with a desired display device; the method including the steps of:
providing a video; and
providing a display information hierarchy for a plurality of display devices, for each display device the display information hierarchy including information related to one or more adjustments to the video prior to presentment with the respective display device.

23. The method of claim 22, wherein the display information hierarchy is provided with the video.

24. The method of claim 23, wherein the display information hierarchy is provided in metadata associated with the video.

25. The method of claim 23, wherein the display information hierarchy is provided in a watermark associated with the video.

26. The method of claim 25, wherein the display information hierarchy is provided in ancillary data associated with the video.

27. The method of claim 22, wherein the display information hierarchy is provided independent from the video.

28. The method of claim 27, wherein the display information hierarchy is accessible over a network.

29. The method of claim 22, wherein at least one of the one or more adjustments specifies scene-by-scene adjustments.

30. The method of claim 22, wherein at least one of the one or more adjustments specifies frame-by-frame adjustments.

31. The method of claim 22, wherein at least one of the one or more adjustments specifies an adjustment to a sub-region of at least one frame.

32. A method of preparing a tailored video for presentment with a desired display device; the method including the steps of:
providing a video;
providing a library of information related to one or more adjustments to the video prior to presentment with the respective display device; and
selecting from the library information related to one or more adjustments to the video for the desired display device if the desired display device is identified in the library, and in the case wherein the desired display device is not identified in the library then selecting information related to one or more adjustments to the video for a classification including the desired display device.

33. The method of claim 32, wherein the library is provided with the video.

34. The method of claim 33, wherein the library is provided in metadata associated with the video.

35. The method of claim 33, wherein the library is provided in a watermark associated with the video.

36. The method of claim 33, wherein the library is provided in ancillary data associated with the video.

37. The method of claim 32, wherein the library is provided independent from the video.

38. The method of claim 32, wherein the library is accessible over a network.

39. The method of claim 32, wherein at least one of the one or more adjustments specifies scene-by-scene adjustments.

40. The method of claim 32, wherein at least one of the one or more adjustments specifies frame-by-frame adjustments.

41. The method of claim 32, wherein at least one of the one or more adjustments specifies an adjustment to a sub-region of at least one frame.

42. A method of improving the eventual display of a video on a display device having a plurality of display parameters; the method including the steps of:
receiving a video from one or more cameras which are acquiring a scene;
presenting at least a first image of the video on a video monitor;
selecting a first display profile for a first display device from a plurality of display profiles;
emulating at least the first image the video on the first display device based on the first display profile;
presenting the emulated at least the first image of the video on the video monitor;
adjusting the display of the at least the first image of the video to improve the eventual appearance of the at least the first image of the video on the first display device; and
storing the adjustment.

43. The method of claim 42, wherein the adjustment is provided with the at least the first image of the video.

44. The method of claim 43, wherein the adjustment is provided in metadata associated with the at least the first image of the video.

45. The method of claim 43, wherein the adjustment is provided in a watermark associated with the at least the first image of the video.

46. The method of claim 43, wherein the adjustment is provided in ancillary data associated with the at least the first image of the video.

47. A method of improving the display of a display device having a plurality of display parameters, the method including the steps of:
receiving a video and an adjustment to the video which is provided to improve the presentation of the video with the display device, the adjustment being provided in a watermark; and
displaying the video with the display device based on the adjustment provided in the watermark.

48. The method of claim 47, wherein the adjustment is selected from a plurality of adjustments.

49. The method of claim 47, wherein the adjustment is related to a group of display devices including the display device.

50. The method of claim 47, wherein the adjustment specifies scene-by-scene adjustments.

51. The method of claim 47, wherein the adjustment specifies frame-by-frame adjustments.

52. The method of claim 47, wherein the adjustment specifies an adjustment to a sub-region of at least one frame.

53. A method of improving the display of a display device having a plurality of display parameters, the method including the steps of:
providing a video and an adjustment to the video which is provided to improve the presentation of the video with the display device, the adjustment being provided in a watermark; and
displaying the video with the display device based on the adjustment provided in the watermark.

54. The method of claim 53, wherein the adjustment is selected from a plurality of adjustments.

55. The method of claim 53, wherein the adjustment is related to a group of display devices including the display device.

56. The method of claim 53, wherein the adjustment specifies scene-by-scene adjustments.

57. The method of claim 53, wherein the adjustment specifies frame-by-frame adjustments.

58. The method of claim 53, wherein the adjustment specifies an adjustment to a sub-region of at least one frame.
